(19) United States
(12) Patent Application Publication
(10) Pub. No.: US 2023/0261547 A1
(43) Pub. Date: Aug. 17, 2023

(54) DRIVE ASSEMBLY FOR A VEHICLE, AND VEHICLE WITH A DRIVE ASSEMBLY

(71) Applicant: Robert Bosch GmbH, Stuttgart (DE)

(72) Inventors: Igor Schleining, Stuttgart (DE); Witold Techman, Bietigheim-Bissingen (DE)

(21) Appl. No.: 18/001,729

(22) PCT Filed: May 17, 2021
(86) PCT No.: PCT/EP2021/062975

§ 371 Date: Dec. 14, 2022

(30) Foreign Application Priority Data
Jun. 15, 2020 (DE) 10 2020 207 346.5

(51) Int. Cl. H02K 9/193; H02K 5/20; H02K 11/33

(52) U.S. Cl. CPC H02K 9/193; H02K 5/203; H02K 11/33

(57) ABSTRACT

The invention relates to a drive assembly for a vehicle comprising a system housing with a first housing part and a second housing part. Power electronics designed to convert a direct voltage into an alternating voltage are arranged in the first housing part. An electric machine which is electrically connected to the power electronics is arranged in the second housing part. The drive assembly furthermore comprises a first coolant channel, which is designed to cool the power electronics, a second coolant channel, which is designed to cool the electric machine, and a coolant transfer point, which connects the first coolant channel and the second coolant channel fluidically with each other and is arranged outside the system housing of the drive assembly.

### BACKGROUND

Typically, cooling systems for electric vehicle axles have a common cooling channel for cooling an inverter and an electric motor. A coolant flows through the common cooling channel first in the region of the inverter and then in the region of the electric motor. A transfer point of the coolant from the region of the inverter to the region of the electric motor is usually located within a housing of the electric vehicle axle.

DE 10 2013 204 766 A1 describes an electric vehicle axle device which has a common cooling circuit for cooling an electric motor, power electronics, a transmission, and a vehicle axle.

DE 10 2018 111 624 A1 describes an integrated drive system which comprises a cooling system with a cooling liquid and a cooling path for cooling an inverter, a rotor, a stator, and a transmission.

EP 2 849 318 A2 describes a drive unit for a vehicle. The drive unit comprises an electric motor and an inverter, the electric motor and the inverter being connected to a common cooling circuit.

### SUMMARY

According to the invention, a drive assembly for a vehicle and a vehicle comprising a drive assembly are provided.

Advantageous embodiments or developments are the subject matter of the respective dependent claims, the description, and the reference to the figures.

According to a first aspect of the invention, a drive assembly for a vehicle comprises a system housing having a first housing part and a second housing part.

Power electronics configured to convert a direct voltage into an alternating voltage are arranged in the first housing part. The first housing part may completely or partially delimit a first interior space, in which the power electronics are arranged. The power electronics may have an inverter circuit, for example. Optionally, the power electronics may also comprise a DC-DC converter. The DC-DC converter may, for example, be configured to convert a direct voltage supplied by a high-voltage battery into a direct voltage having a higher, lower, or inverted voltage level, in order to supply on-board electronics with power, for example.

An electric machine is arranged in the second housing part and is electrically connected to the power electronics. The second housing part may completely or partially delimit a second interior space, in which the electric machine is arranged. The first interior space of the first housing part and the second interior space of the second housing part may form a common interior space, for example. Alternatively, the first interior space of the first housing part and the second interior space of the second housing part may be spatially separated interior spaces. The first interior space of the first housing part and the second interior space of the second housing part may, for example, be separated from one another by a common partition wall. The electric machine may be operated as a motor or as a generator. Furthermore, a torque can be generated by means of the electric machine, it being possible for the electric machine to be kinematically connected to at least one wheel of the vehicle in such a way that a torque can be transmitted between the electric machine and the at least one wheel.

The drive assembly further comprises a first cooling channel, which is designed to cool the power electronics, and a second cooling channel, which is designed to cool the electric motor. The first cooling channel extends at least in part in the first interior space of the first housing part, in which the power electronics are arranged. The first cooling channel may protrude in part from the first housing part. In particular, an end piece of the first cooling channel may protrude from the first housing part. The second cooling channel extends at least in part in the second interior space of the second housing part, in which the electric machine is arranged. The second cooling channel may protrude in part from the second housing part. In particular, an end piece of the second cooling channel may protrude from the second housing part.

Furthermore, the drive assembly comprises a coolant transfer point, which connects the first cooling channel and the second cooling channel fluidically to one another and is arranged outside the system housing of the drive assembly. In particular, the coolant transfer point can fluidically connect the end piece of the first cooling channel, which optionally protrudes from the first housing part, to the end piece of the optionally second cooling channel, which protrudes from the second housing part.

Alternatively or additionally, the coolant transfer point arranged outside the system housing of the drive assembly may project into the first housing part and/or into the second housing part. In general terms, the coolant transfer point is thus designed as a line piece which fluidically connects the first and the second cooling channel.

According to a second aspect of the invention, a vehicle is provided which comprises at least one wheel and the drive assembly according to the first aspect of the invention. The electric machine is kinematically connected to the at least one wheel in such a way that a torque can be transmitted between the electric machine and the at least one wheel. The vehicle may be a two-track motor vehicle, in particular a passenger car or a truck, or a single-track motor vehicle, for example a motorcycle. Furthermore, the vehicle may, for example, be an electrically operated vehicle or a hybrid vehicle. The vehicle may further comprise at least one first axle and one second axle, at least one wheel being arranged on each axle. Optionally, the vehicle may comprise two or more drive assemblies. This has the advantage that each wheel can be accelerated individually by means of the drive assemblies.

One idea underlying the invention is to provide a drive assembly which has a coolant transfer point which is arranged outside the system housing of the drive assembly in order to minimize the risk of damage to or failure of the drive assembly, in particular the power electronics and the electric machine, in the event of a leak at the coolant transfer point.

An advantage of the invention is that egress of fluid within the system housing is counteracted by means of the arrangement of the coolant transfer point outside the system housing of the drive assembly. The reliability of the drive assembly is thus improved and the probability of a total failure of the drive assembly is reduced. Another advantage of the invention is that, due to the arrangement of the coolant transfer point outside the system housing of the drive assembly, demands on the tightness of the coolant transfer point against egress of fluid can be reduced. The result is a reduction in the costs during manufacture or production of the drive assembly.

According to some embodiments, the drive assembly may have a transmission which can be kinematically connected to the electric machine and at least one wheel of the vehicle and which can be configured to absorb the torque of the electric machine and to transmit it to the at least one wheel of the vehicle.

According to one embodiment, the drive assembly may comprise a coolant inlet point for supplying fluid. The coolant inlet point is fluidically connected to the first cooling channel. The coolant inlet point may be fluidically connected to a cooling circuit of the vehicle, by means of which the fluid is guided to the coolant inlet point.

According to another embodiment, the drive assembly may comprise a coolant outlet point for discharging fluid. The coolant outlet point is fluidically connected to the second cooling channel. The coolant outlet point may be fluidically connected to a cooling circuit of the vehicle, by means of which the fluid can be guided away from the coolant outlet point. Alternatively, the coolant outlet point may be fluidically connected to the coolant inlet point, such that a closed circuit is formed within the drive assembly. The connection from the coolant outlet point to the coolant inlet point may extend within or outside the system housing.

According to another embodiment, the first cooling channel may extend in the first housing part and at least in part in the region of the power electronics. The first cooling channel extends at least in part in the first interior space of the first housing part, in which the power electronics are arranged. For example, the first cooling channel may extend along one or more side surfaces of the power electronics. The first cooling channel may also completely or partially surround the power electronics, for example. With a corresponding geometry of the power electronics, the first cooling channel may also extend through the power electronics. The arrangement of the first cooling channel at least in part within the first housing part produces the advantage that the cooling channel is arranged spatially close to the power electronics, thereby improving the cooling capacity. Furthermore, the space needed for the cooling is further reduced as a result.

According to another embodiment, the second cooling channel may extend in the second housing part and at least in part in the region of the electric machine. The second cooling channel extends at least in part in the second interior space of the second housing part, in which the electric machine is arranged. For example, the second cooling channel may extend along one or more side surfaces of the electric machine. The second cooling channel may also completely or partially surround the electric machine, for example. An advantage of arranging the second cooling channel within the second housing part is that a high cooling capacity of the second cooling channel can be achieved. Another advantage is that the second cooling channel can be adapted to individual geometric requirements of the electric machine, of the second housing part, and/or of the system housing.

According to another embodiment, the coolant transfer point may be designed as a flexible hose, as a plastics pipe, as an aluminum pipe, or as a steel pipe. The flexible hose may be a flexible plastics hose which may be designed, for example, as a non-corrugated plastics hose having a smooth hose surface or may be designed, for example, as a corrugated plastics hose having a corrugated surface and an annular corrugation. The flexible hose may be designed to connect the first cooling channel and the second cooling channel fluidically to one another. The flexible hose has the advantage that, in the event of a defect of the flexible hose, the flexible hose can be replaced particularly simply. The plastic pipe may be a thermosetting plastic pipe and is designed to connect the first cooling channel and the second cooling channel fluidically to one another. The plastic pipe offers the advantage of a particularly robust and, at the same time, lightweight coolant transfer point. The aluminum pipe is designed to connect the first cooling channel and the second cooling channel fluidically to one another. The aluminum pipe has the advantage of forming a particularly stable coolant transfer point which is at the same time insensitive to temperature fluctuations. The steel pipe is designed to connect the first cooling channel and the second cooling channel fluidically to one another. The steel pipe offers the advantage of being particularly stable and cost-effective.

According to another embodiment, the coolant transfer point may comprise a first hose clamp, which is designed to seal an end piece of the first cooling channel and the coolant transfer point against egress of fluid into a region surrounding the coolant transfer point. Furthermore, the coolant transfer point may comprise a second hose clamp, which is designed to seal an end piece of the second cooling channel and the coolant transfer point against egress of the fluid into the region surrounding the coolant transfer point. The first hose clamp and the second hose clamp may be designed, for example, as an annular metal strip or as an annular plastic strip. This has the advantage that, in the event of a defect of the coolant transfer point, it is possible to manually replace the coolant transfer point and/or the first hose clamp and the second hose clamp in a simple manner.

According to another embodiment, the coolant transfer point may comprise a first O-ring, which is designed to seal a first end piece of the first cooling channel and the coolant transfer point against egress of fluid into a region surrounding the coolant transfer point. Furthermore, the coolant transfer point may comprise a second O-ring, which is designed to seal a second end piece of the second cooling channel and the coolant transfer point against egress of the fluid into the region surrounding the coolant transfer point. An O-ring can be understood to mean an annular sealing element consisting of plastics material or metal. The first O-ring may optionally be arranged on a first overlap surface between the first end piece of the first cooling channel and the coolant transfer point. The first overlap surface is a region in which the first cooling channel and the coolant transfer point are pushed one into the other, it being possible for the end region of the first cooling channel to protrude into the coolant transfer point or for the end of the coolant transfer point to protrude into the first cooling channel. The second O-ring may optionally be arranged on a second overlap surface between the second end piece of the second cooling channel and the coolant transfer point. The second overlap surface is a region in which the second cooling channel and the coolant transfer point are pushed one into the other, it being possible for the end region of the second cooling channel to protrude into the coolant transfer point or for the end of the coolant transfer point to protrude into the second cooling channel. This offers the advantage of cost-effective and space-saving sealing of the coolant transfer point.

According to another embodiment, a first end piece of the first cooling channel may be overmolded on the coolant transfer point in order to seal the coolant transfer point against egress of fluid into a region surrounding the coolant transfer point. Furthermore, a second end piece of the second cooling channel may be overmolded on the coolant transfer point in order to seal the coolant transfer point against egress of the fluid into the region surrounding the coolant transfer point. The first end piece of the first cooling channel and the second end piece of the second cooling channel form, for example, a pre-molded part which is overmolded by means of an injection molding material. The injection molding material surrounding the pre-molded part forms the coolant transfer point. This offers the advantage that the coolant transfer point forms an integral bond with the end piece of the first cooling channel and with the end piece of the second cooling channel that has a high degree of tightness.

### BRIEF DESCRIPTION OF THE DRAWINGS

The invention is explained below with reference to the figures of the drawings. In the drawings:

FIG. 1 is a schematic sectional representation of a drive assembly according to an embodiment of the invention;

FIG. 2 is a schematic perspective representation of the drive assembly from FIG. 1;

FIG. 3 is a schematic perspective representation of the drive assembly from FIG. 1 from another perspective; and

FIG. 4 is a schematic plan view of the drive assembly from FIG. 1.

### DETAILED DESCRIPTION

In all figures, identical or functionally identical elements and devices are provided with the same reference signs.

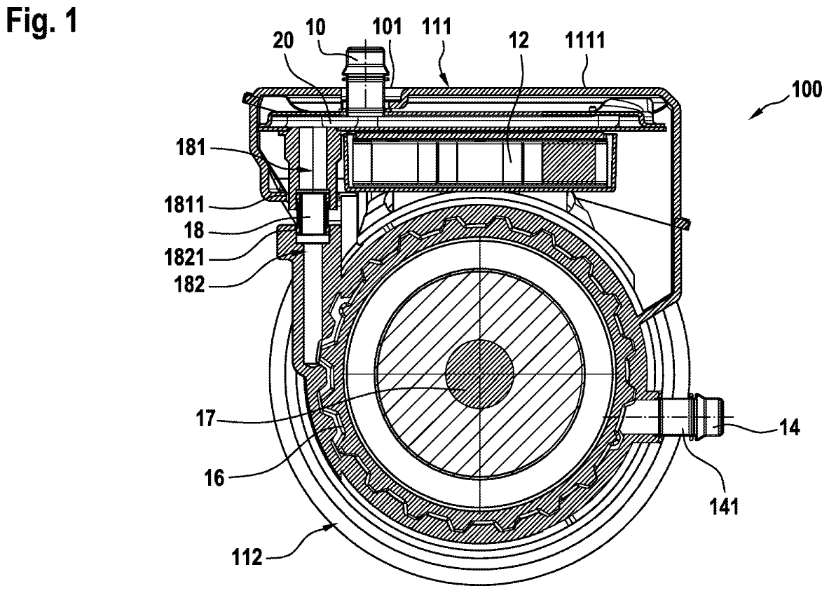

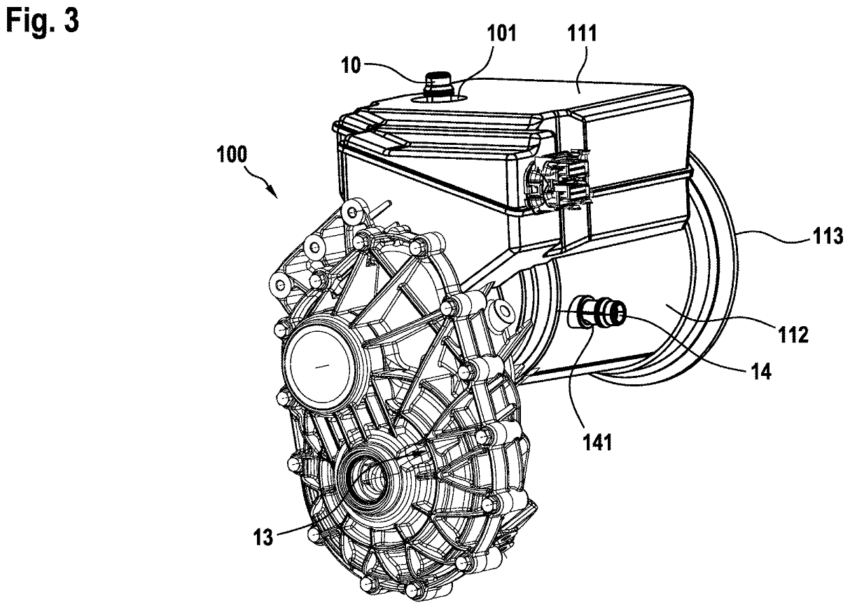

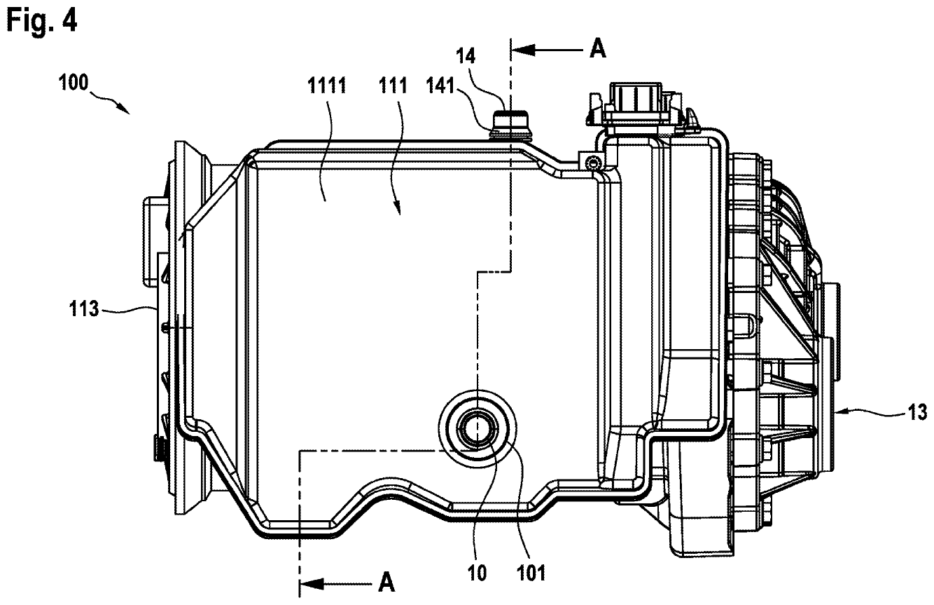

FIGS. 1 to 4 show a schematic sectional representation, schematic perspective representations, and a plan view of a drive assembly 100 for a vehicle. The drive assembly 100 comprises a system housing having a first housing part 111 and a second housing part 112. Power electronics 12 are arranged in the first housing part 111. An electric machine 17 is arranged in the second housing part and is electrically connected to the power electronics 12. A first cooling channel 20 extends in the first housing part 111 adjacently to the power electronics 12. The first cooling channel 20 is fluidically connected to a second cooling channel 16 via a coolant transfer point 18. The coolant transfer point 18 is arranged outside the system housing. The second cooling channel 16 extends in the second housing part 112 adjacently to the electric machine 17.

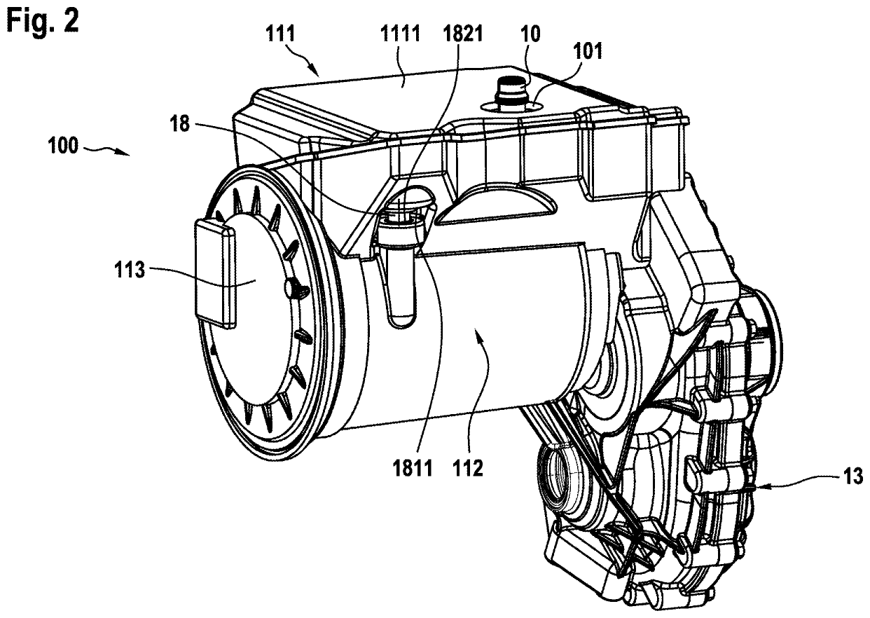

As shown in FIG. 2, the first housing part 111 may comprise a first cover 1111. The first cover 1111 may be part of the first housing part 111 or may be designed as a separate element which closes the first housing part 111. The first cover 1111 of the first housing part 111 may comprise a first opening 101. As shown in FIG. 1, in particular, a coolant inlet point 10 may penetrate the first cover 1111 of the first housing part 111 at the first opening 101. The coolant inlet point 10 is fluidically connected to the first cooling channel 20 and is designed to supply fluid, in particular a coolant, to the first cooling channel 20. The coolant inlet point may, for example, be fluidically connected to a cooling circuit of the vehicle, by means of which the fluid is guided to the coolant inlet point. As shown in FIG. 2, in particular, the first opening 101 may be designed such that it has an annular free space or air gap around the coolant inlet point 10, such that the first cover and the coolant inlet point 10 are not in direct contact with one another at the first opening 101. Alternatively, the first opening 101 may be designed, for example by means of a sealing ring, such that the first opening 101 does not have an annular free space or air gap around the coolant inlet point 10. This has the advantage that the first housing part 111 is sealed at the first opening 101 against undesired ingress of fluid into the system housing or egress of fluid from the system housing.

As shown by way of example in FIG. 1, the first cooling channel 20 extends within the first housing part 111. The first cooling channel 20 may extend in part between the power electronics 12 and the first cover 1111 of the first housing part 111 and in part along the power electronics. However, shapes of the cooling channel 20 other than that illustrated here are also conceivable.

The first housing part 111 may further comprise a second opening 1811, for example on a region of the housing wall facing the second housing part 112, as schematically illustrated in FIGS. 1 and 2. The first cooling channel 20 may comprise a first end piece 181, which penetrates the first housing part 111 at the second opening 1811 and which is fluidically connected to the coolant transfer point 18. The connection between the first end piece 181 and the coolant transfer point 18 may be sealed in such a way that egress of fluid into a region surrounding the coolant transfer point 18 is prevented. The sealing may optionally be achieved by means of a first hose clamp, a first O-ring, or overmolding of the first end piece.

The first hose clamp may be designed to seal the first end piece 181 of the first cooling channel 20 and the coolant transfer point 18 against egress of fluid into the region surrounding the coolant transfer point 18. The first hose clamp may be designed as an annular metal strip, it being possible to reduce an internal diameter of the annular metal strip by means of an adjusting screw in order to seal the first end piece 181 of the first cooling channel 20 and the coolant transfer point 18.

The first O-ring may be designed to seal the first end piece 181 of the first cooling channel 20 and the coolant transfer point 18 against egress of fluid into the region surrounding the coolant transfer point 18. The first O-ring may be designed as an annular resilient sealing element consisting of plastic. Preferably, the first O-ring is arranged on a first overlap surface between the first end piece 181 of the first cooling channel 20 and the coolant transfer point 18. The first overlap surface may be a region in which the first end piece 181 of the first cooling channel 18 is pushed into the coolant transfer point 18. The first cooling channel 20 is thus pushed in part into the coolant transfer point 18. In an alternative embodiment, the coolant transfer point 18 may be pushed in part into the first cooling channel 181. The first O-ring may accordingly be arranged on the first overlap surface between the first end piece 181 of the first cooling channel 20 and the coolant transfer point 18.

The first end piece 181 of the first cooling channel 20 may be overmolded on the coolant transfer point 18 in order to seal the coolant transfer point 18 against egress of fluid into the region surrounding the coolant transfer point 18. The first end piece 181 of the first cooling channel 20 and a second end piece 182 of the second cooling channel 16 may form a pre-molded part. The pre-molded part is overmolded with an injection molding material. The injection molding material, which overmolds the pre-molded part, forms the coolant transfer point.

As shown in FIGS. 1 and 2, the coolant transfer point 18 is fluidically connected to the first cooling channel 20, which is located within the first housing part 111. Furthermore, the coolant transfer point 18 is fluidically connected to the second cooling channel 16, which is located within the second housing part 112. Therefore, the coolant transfer point 18 connects the first cooling channel 20 and the second cooling channel 16 fluidically to one another. The coolant transfer point 18 may be designed, for example, as a flexible hose, as a plastics pipe, as an aluminum pipe, or as a steel pipe.

As shown in FIGS. 1 and 2, the second housing part 112 may comprise a third opening 1821, in particular on a region of the housing wall facing the first housing part 111. The second housing part 112 may comprise a second cover 113, which may be designed to close the second housing part 112. The second cover 113 may be part of the second housing part 112 or may be a separate element which closes the second housing part 112. When the second cover 113 is open, manual access to the electric machine 17, for example for repairs, may be possible. The second cooling channel 20 may comprise a second end piece 182, which penetrates the second housing part 112 at the third opening 1821 and is fluidically connected to the coolant transfer point 18. The connection between the second end piece 182 and the coolant transfer point 18 is sealed in such a way that egress of fluid into the region surrounding the coolant transfer point 18 is prevented. The sealing may optionally be achieved by means of a second hose clamp, a second O-ring, or overmolding of the second end piece.

The second hose clamp may be designed to seal the second end piece 182 of the second cooling channel 16 and the coolant transfer point 18 against egress of fluid into the region surrounding the coolant transfer point 18. The second hose clamp may be designed as an annular metal strip, it being possible to reduce an internal diameter of the annular metal strip by means of an adjusting screw in order to seal the second end piece 182 of the second cooling channel 16 and the coolant transfer point 18.

The second O-ring may be designed to seal the second end piece 182 of the second cooling channel 16 and the coolant transfer point 18 against egress of fluid into the region surrounding the coolant transfer point 18. The second O-ring may be designed as an annular resilient sealing element consisting of plastics material. Preferably, the second O-ring is arranged on a second overlap surface between the second end piece 182 of the second cooling channel 16 and the coolant transfer point 18. The second overlap surface is produced by pushing the second end piece 182 of the second cooling channel 16 into the coolant transfer point 18. The second cooling channel 16 is pushed in part into the coolant transfer point 18 so as to produce the second overlap surface. In an alternative embodiment, the coolant transfer point 18 is pushed in part into the second cooling channel 182 so as to also produce a second overlap surface. The second O-ring may accordingly be arranged on the second overlap surface between the second end piece 182 of the second cooling channel 16 and the coolant transfer point 18.

It is also conceivable for the second end piece 182 of the second cooling channel 16 to be overmolded on the coolant transfer point 18 in order to seal the coolant transfer point 18 against egress of fluid into the region surrounding the coolant transfer point 18. The first end piece 181 of the first cooling channel 20 and the second end piece 182 of the second cooling channel 16 may form the pre-molded part. The pre-molded part may be overmolded with the injection molding material. The injection molding material, which overmolds the pre-molded part, may form the coolant transfer point.

The second cooling channel 16 may extend, in particular, within the second housing part 112, as is shown by way of example in FIG. 1. As shown by way of example in FIG. 1, the second cooling channel 16 may extend in part as an annular cooling channel around the electric machine. The second cooling channel 16 may be fluidically connected to the coolant transfer point 18 by means of the second end piece 182. However, shapes of the cooling channel 16 other than that illustrated here are also conceivable.

The second housing part 112 may comprise a fourth opening 141, as shown by way of example in FIGS. 1, 3, and 4. A coolant outlet point 14 penetrates the second housing part 112 at the fourth opening 141. The coolant outlet point 14 is fluidically connected to the second cooling channel 16 and is designed to discharge fluid. The coolant outlet point is fluidically connected to the cooling circuit of the vehicle, by means of which the fluid is guided away from the coolant outlet point. The fourth opening 141 may be designed such that it has an annular free space or air gap around the coolant outlet point 14, and therefore the second housing part 112 and the coolant outlet point 14 are not in direct contact with one another at the fourth opening 141. Alternatively, the fourth opening 141, for example by means of a sealing ring, may be designed such that the fourth opening 141 does not have an annular free space or air gap around the coolant outlet point 14. This has the advantage that the second housing part 112 is sealed at the fourth opening 141 against undesired ingress of fluid into the system housing or egress of fluid from the system housing.

1. A drive assembly (100) for a vehicle, comprising:
a system housing having a first housing part (111) and a second housing part (112);
power electronics (12), which are arranged in the first housing part (111) and are configured to convert a direct voltage into an alternating voltage;
an electric machine (17), which is arranged in the second housing part (112) and is electrically connected to the power electronics (12);
a first cooling channel (20), which is designed to cool the power electronics (12);
a second cooling channel (16), which is designed to cool the electric machine (17);
a coolant transfer point (18), which connects the first cooling channel (20) and the second cooling channel (16) fluidically to one another and which is arranged outside the system housing of the drive assembly (100).

2. The drive assembly (100) according to claim 1, wherein the drive assembly (100) comprises a coolant inlet point (10) for supplying fluid, and wherein the coolant inlet point (10) is fluidically connected to the first cooling channel (20).

3. The drive assembly (100) according to claim 1, wherein the drive assembly (100) comprises a coolant outlet point (14) for discharging fluid, and wherein the coolant outlet point (14) is fluidically connected to the second cooling channel (16).

4. The drive assembly (100) according to claim 1, wherein the first cooling channel (20) extends in the first housing part (111) and at least in part in a region of the power electronics (12).

5. The drive assembly (100) according to claim 1, wherein the second cooling channel (16) extends in the second housing part (112) and at least in part in a region of the electric machine (17).

6. The drive assembly (100) according to claim 1, wherein the coolant transfer point (18) includes a flexible hose, a plastics pipe, an aluminum pipe, or a steel pipe.

7. The drive assembly (100) according to claim 1, wherein the coolant transfer point (18) comprises a first hose clamp, which is designed to seal a first end piece (181) of the first cooling channel (20) and the coolant transfer point (18) against egress of fluid into a region surrounding the coolant transfer point (18), and comprises a second hose clamp, which is designed to seal a second end piece (182) of the second cooling channel (16) and the coolant transfer point (18) against egress of the fluid into the region surrounding the coolant transfer point (18).

8. The drive assembly (100) according to claim 1, wherein the coolant transfer point (18) comprises a first O-ring, which is designed to seal a first end piece (181) of the first cooling channel (20) and the coolant transfer point (18) against egress of fluid into a region surrounding the coolant transfer point (18), and comprises a second O-ring, which is designed to seal a second end piece (182) of the second cooling channel (16) and the coolant transfer point (18) against egress of the fluid into the region surrounding the coolant transfer point (18).

9. The drive assembly (100) according to claim 1, wherein a first end piece (181) of the first cooling channel (20) is overmolded on the coolant transfer point (18) in order to seal the coolant transfer point (18) against egress of fluid into a region surrounding the coolant transfer point (18), and wherein a second end piece (182) of the second cooling channel (16) is overmolded on the coolant transfer point (18) in order to seal the coolant transfer point (18) against egress of the fluid into the region surrounding the coolant transfer point (18).

10. A vehicle comprising
at least one wheel;
a drive assembly (100) according to claim 1, wherein the electric machine (16) is kinematically connected to the at least one wheel in such a way that a torque can be transmitted between the electric machine (16) and the at least one wheel.

11. The drive assembly (100) according to claim 2, wherein the drive assembly (100) comprises a coolant outlet point (14) for discharging fluid, and wherein the coolant outlet point (14) is fluidically connected to the second cooling channel (16).
